(19) United States
(12) Patent Application Publication
(10) Pub. No.: US 2025/0145158 A1
(43) Pub. Date: May 8, 2025

(54) DRIVER-ASSISTANCE SYSTEM FOR CONTROLLING A SPEED OF A VEHICLE DEPENDENT ON A WEIGHTING OF SPEEDS OF FURTHER VEHICLES IN FRONT OF THE VEHICLE TO EACH OTHER

(71) Applicant: FEV Group GmbH, Aachen (DE)

(72) Inventors: Satyum Joshi, Farmington Hills, MI (US); Sumit Paul, Auburn Hills, MI (US)

(21) Appl. No.: 18/504,610

(22) Filed: Nov. 8, 2023

(51) Int. Cl. B60W 30/16

(52) U.S. Cl. CPC B60W 30/162; B60W 2554/402; B60W 2554/4042; B60W 2554/80

(57) ABSTRACT

The present disclosure relates to a driver-assistance system for controlling a speed of a vehicle dependent on at least two further vehicles in front of the vehicle, the driver-assistance system including a control system and a sensor system for detecting a respective further speed of the respective further vehicle, wherein the control system is configured to perform a weighting of the further speeds to each other and to determine a target speed of the vehicle dependent on the respective further speed and dependent on the weighting of the further speeds and to control the speed of the vehicle dependent on the target speed.

### TECHNICAL FIELD

The present disclosure relates in general to the field of automated and semi-automated control of a vehicle and, in particular, to a driver-assistance system for controlling a speed of a vehicle and a method for controlling a speed of a vehicle.

### BACKGROUND

It is known to control a speed of a vehicle dependent on a speed of a further vehicle driving directly in front of the vehicle. Conventional adaptive cruise control (ACC) systems may be designed to calculate a target speed of the vehicle dependent on the speed of this further vehicle and to control the speed of the vehicle dependent on the target speed such that the vehicle follows the further vehicle.

### SUMMARY

Various embodiments provide a driver-assistance system for controlling a speed of a vehicle and a method for controlling a speed of a vehicle described by the subject matter of the independent claims. Advantageous embodiments are described in the dependent claims. Embodiments of the present disclosure can be freely combined with each other if they are not mutually exclusive.

In one aspect, the present disclosure relates to a driver-assistance system for controlling a speed of a vehicle dependent on at least two further vehicles in front of the vehicle. The driver-assistance system may include a control system and a sensor system for detecting a respective further speed of the respective further vehicle. The control system is configured to perform a weighting of the further speeds to each other and to determine a target speed of the vehicle dependent on the respective further speed and dependent on the weighting of the respective further speed. Furthermore, the control system is configured to control the speed of the vehicle dependent on the target speed.

The driver-assistance system may allow to compute the target speed such that a respective influence of the respective further speed on the target speed may be different compared to the respective one of the other further speed because the control system is configured to perform the weighting of the respective further speed. The more the respective further speed is weighted by the control system, the stronger or greater amount the respective influence of the respective further speed on a computation of the target speed. In one example, the control system may be configured to calculate a respective product of the respective further speed and a respective weighting factor in order to perform the weighting of the respective further speed. Following this example, the control system may be configured to calculate the target speed dependent on a sum of the respective products. In one example, the target speed may be equal to the sum of the respective products.

Generally, taking into account the further speeds of the at least two further vehicles in front of the vehicle for controlling the speed of the vehicle may allow to control the speed of the vehicle such that a fuel consumption of the vehicle may be reduced. This is due to the fact that a variation of a weighted sum of the two further speeds over time may be less than a variation of the respective individual further speed over time in most cases. As the target speed is calculated dependent on the respective further speed, a variation of the target speed over time may be reduced in most cases as a result. Since the target speed serves as a set point for the speed of the vehicle when controlling the speed of the vehicle by the control unit, this may reduce a variation of the acceleration of the vehicle over time and therefore may reduce the fuel consumption of the vehicle and may enhance the driving comfort.

Generally, the weighting may be performed such that either the further speed of the further vehicle that is closer to the vehicle is weighted greater than the further speed of the other further vehicle or vice versa. In the first case, the control system may perform the controlling of the speed of the vehicle with the focus on keeping a predetermined desirable or efficient distance to the further vehicle that is next to the vehicle, in the following also referred to as closest lead vehicle. However, the fuel consumption may still be reduced compared to a controlling of the speed which would take into account only the further speed of the closest lead vehicle. In the other case, the control system may perform the controlling of the speed of the vehicle with a higher focus on reducing the fuel consumption of the vehicle. In this case, a distance between the vehicle and the closest lead vehicle may be occasionally less than the predetermined desirable or efficient distance according to one example.

Generally, the weighting of the respective further speed may allow to adapt a computation of the target speed to a usage of the vehicle. In one example, the weighting may depend on a type of the vehicle. For example, wherein when the vehicle is a police car, the influence of the further speed of the closest lead vehicle may be greater on the computation of the target speed than the influence of the further speed of the other further vehicle. In case the vehicle is a truck, the influence of the further speed of the closest lead vehicle may be smaller on the computation of the target speed than the influence of the further speed of the other further vehicle. Hence, wherein when the vehicle is a police car, the driver-assistance system may allow a better tracking of the closest lead vehicle, and wherein when the vehicle is a truck, the driver-assistance system may enable a computation of the target speed such that a fuel consumption of the vehicle may be reduced to a higher degree.

According to one embodiment, the control system may be configured to adapt the weighting to a traffic situation involving the vehicle and the at least two further vehicles. This may enable the driver-assistance system to execute a control strategy for controlling the speed dependent on the traffic situation. For example, wherein when the speed of the closest lead vehicle varies over time periodically in a higher rate than the speed of the other further vehicle, the weighting may be adapted such that the further speed of the other further vehicle has a greater influence on the target speed compared to the further speed of the closest lead vehicle. The further speed of the closest lead vehicle may be weighted less than the further speed of the other further vehicle in this case. In one example, the control system may be configured to detect the traffic situation, such as based on sensor data generated by the sensor system.

Adapting the weighting to the traffic situation may allow to reduce the fuel consumption of the vehicle even further compared to an embodiment according to which the weighting of the further speeds to each other is fixed over time and is not adapted to the traffic situation. Furthermore, adapting the weighting to the traffic situation and use the weighting to calculate the target speed for controlling the speed may require less computational effort and may therefore allow a real-time controlling of the speed taking into account the further vehicles compared to an approach according to which the states of the further vehicles are predicted to determine optimal control inputs for controlling the speed by solving numerical optimization problems.

According to a further embodiment, the traffic situation may be specifiable by a respective driving pattern of the respective further vehicle. According to this embodiment, the control system may be configured to adapt the weighting of the further speeds dependent on the respective driving pattern. In one example, the respective driving pattern may be described with a respective level of fluctuation of the respective further speed over time. The control system may be configured to adapt the weighting of the further speeds such that the more constant the respective further speed is over time, the stronger or greater amount the respective further speed is weighted. The control system may be configured to detect the respective driving pattern, in particular by the sensor data. Adapting the weighting of the further speeds dependent on the respective driving pattern may allow to control the speed of the vehicle such that the speed of the vehicle may follow the further speed of whichever of the two further vehicles drives more fuel-efficiently. Hence, the speed of the vehicle does not necessarily have to follow the further speed of the closest lead vehicle compared to conventional ACC systems. As a result the fuel consumption of the vehicle may be further reduced.

In another aspect, the present disclosure relates to a method for controlling a speed of a vehicle dependent on the at least two further vehicles in front of the vehicle. In a first step, a respective further speed of the respective further vehicle may be detected by a sensor system. In a second step, the weighting of the further speeds to each other may be performed by a control system. In a third step, a target speed of the vehicle may be determined dependent on the respective further speed and dependent on the weighting of the further speeds to each other by the control system. In a fourth step, the speed of the vehicle may be controlled dependent on the target speed by the control system.

In another aspect, the present disclosure relates to a computer program product including instructions, wherein an executing of the instructions by one or more processors initiates the one or more processors to execute the aforementioned method. The dependent claims describe advantageous forms of the system and the method.

### BRIEF DESCRIPTION OF THE SEVERAL VIEWS OF THE DRAWINGS

In the following embodiments of the present disclosure are explained in greater detail, by way of example only, making reference to the drawings in which:

FIG. 1 schematically depicts a vehicle including a driver-assistance system with a sensor system and a control system for controlling a speed of the vehicle according to one or more embodiments shown and described herein;

FIG. 2 schematically illustrates a traffic situation involving the vehicle shown in FIG. 1 and two further vehicles in front of the vehicle according to one or more embodiments shown and described herein;

FIG. 3 schematically depicts step of a method for controlling the speed of the vehicle according to one or more embodiments shown and described herein;

FIG. 4 schematically depicts a data flow for controlling the speed of the vehicle according to one or more embodiments shown and described herein;

FIG. 5 schematically illustrates the control system shown in FIG. 1 with a database according to one or more embodiments shown and described herein; and

FIG. 6 schematically depicts a data flow for computing weighting factors for weighting a respective speed of the two further vehicles shown in FIG. 1 according to one or more embodiments shown and described herein.

### DETAILED DESCRIPTION

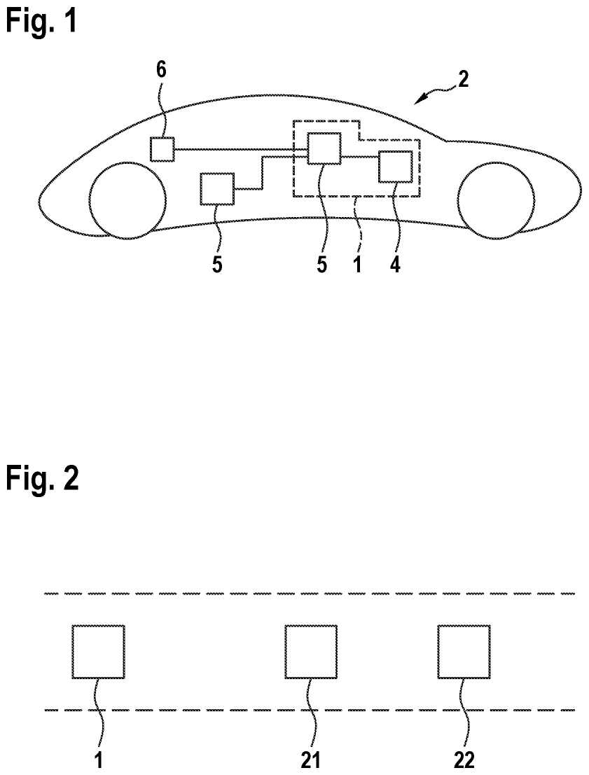

FIG. 1 depicts a driver-assistance system 1 for controlling a speed of a vehicle 2, in the following also referred to as ego speed 101, dependent on further vehicles in front of the vehicle 2, in the following also referred to as leading vehicles. The leading vehicles may include at least two further vehicles, shown in FIG. 2 in the form of a first further vehicle 21 and a second further vehicle 22. The driver-assistance system 1 may include a control system 3 and a sensor system 4 for detecting a respective further speed of the respective leading vehicle, in the following also referred to as respective further speed v_{i,lead}, for example a first further speed v_{1,lead} of the first leading vehicle 21 and a second further speed v_{2,lead} of the second leading vehicle 22. Detecting the respective further speed v_{i,lead} may involve calculating a respective value representing the respective further speed v_{i,lead}. The term “respective further speed v_{i,lead}” may be used in the context of this disclosure to be representative of the respective value representing the respective further speed v_{i,lead}. The sensor system 4 may include one or more lidar sensors, one or more radar sensors and/or one or more cameras for sending out sets of electro-magnetic waves and receiving the respective set of electro-magnetic waves which is reflected at the respective leading vehicle. The sensor system 4 may be configured to generate sensor data 200 on the basis of the received reflected sets of electro-magnetic waves. The sensor data 200 may serve for determining the respective further speed v_{i,lead} or may include the respective further speed v_{i,lead}. In one example, the control system 3 may be configured to calculate the respective further speed v_{i,lead} dependent on the sensor data 200 wherein when the sensor data 200 does not include the respective further speed v_{i,lead}. Hence, in one example, the respective further speed v_{i,lead} may be detected by the sensor system 4 and the control system 3 together.

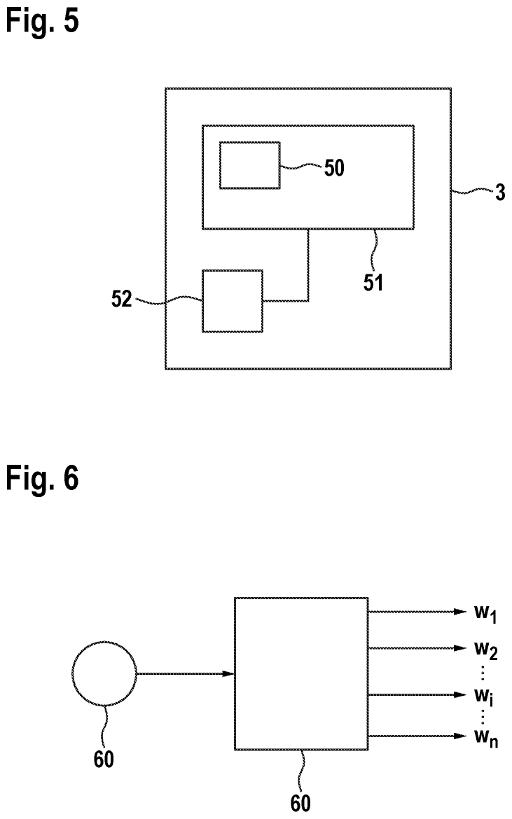

The control system 3 may be an electronic control unit, a central processing unit (CPU), and the like, for performing the functions as described herein. As such, the control system 3 may be configured to receive, analyze and process sensor data, perform calculations and mathematical functions, convert data, generate data, control vehicle system components (e.g., the ego speed 101 via actively controlling the propulsion system 5 and/or the braking system 6), and the like. The control system 3 may include one or more processors 52 (FIG. 5), and other components, for example one or more memory modules 51 (FIG. 5) that stores logic that is executable by the one or more processors and a database 50 (FIG. 5). Each of the one or more processors may be a controller, an integrated circuit, a microchip, central processing unit or any other computing device. The one or more memory modules may be non-transitory computer readable medium and may be configured a RAM, ROM, flash memories, hard drives, and, or any device capable of storing computer-executable instructions, such that the computer-executable instructions can be accessed by the one or more processors. The computer-executable instructions may include logic or algorithms, written in any programming language of any generation such as, for example machine language that may be directly executed by the processors, or assembly language, object orientated programming, scripting languages, microcode, and the like, that may be compiled or assembled into computer-executable instructions and storage on the one or more memory modules. Alternatively, the computer-executable instructions may be written in hardware description language, such as logic implemented via either a field programmable gate array (FPGA) configuration or an application specific integrated circuit (ASIC), all their equivalents. Accordingly, the systems, methods, processes, and/or computer product programs described herein may be implemented in any conventional computer programming language, as preprogrammed hardware elements, or as a combination of hardware and software components. Further, provided herein is a computer program product for use with or by the control system 3 for controlling components of the vehicle 2 (e.g., the ego speed 101 via actively controlling the propulsion system 5 and/or the braking system 6). The computer program product may include a computer usable medium having computer readable instruction or program code embodied on the computer usable medium.

The control system 3 may be configured to perform a weighting of the further speeds of the leading vehicles to each other. Furthermore, the control system 3 may be configured to determine a target speed 100 of the vehicle 2 dependent on the respective further speed v_{i,lead} and dependent on the weighting of the further speeds. In addition, the control system 3 may be configured to control the ego speed 101 dependent on the target speed 100. That is, the control system 3 may physically and actually control various components to control the ego speed 101 dependent on the target speed 100.

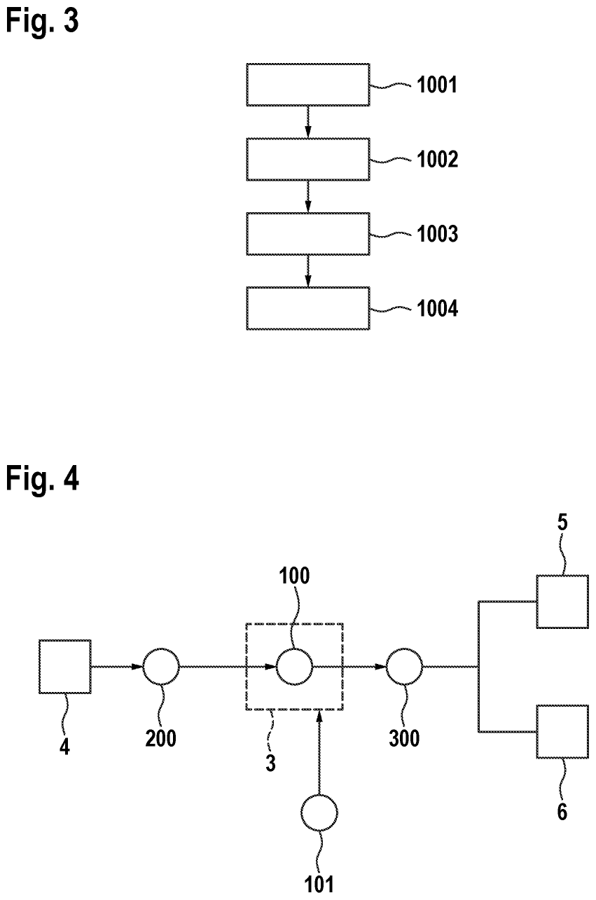

FIG. 3 shows steps of a method for controlling the ego speed 101 dependent on the at least two further vehicles 21, 22. In a first step 1001, the respective further speed v_{i,lead} of the respective further vehicle may be detected by the sensor system 4. In a second step 1002, the weighting of the further speeds to each other may be performed by the control system 3. In a third step 1003, the target speed 100 of the vehicle 2 may be determined dependent on the respective further speed v_{i,lead} and dependent on the weighting of the further speeds to each other by the control system 3. In a fourth step 1004, the ego speed 101 may be controlled dependent on the target speed 100 by the control system 3.

The control system 3 may be connected to a propulsion system 5 of the vehicle 2 and a braking system 6 of the vehicle 2. In one example, the control system 3 may be configured to control the ego speed 101 by sending control signals 300 to the propulsion system 5 and/or the braking system 6. Furthermore, the control system 3 may generate the control signals 300 dependent on the target speed 100.

FIG. 4 depicts a flowchart illustrating a data flow for controlling the ego speed 101. The sensor system 4 may send the sensor data 200 to the control system 3. The control system 3 may calculate the target speed 100 on the basis of the sensor data 200. The sensor data 200 may either include the respective further speed v_{i,lead} or may serve as a basis for calculating the respective further speed v_{i,lead}. Furthermore, the control system 3 may compute the control signals 300 on the basis of the target speed 100 and the ego speed 101. The ego speed 101 may be measured by a speed sensor of the vehicle 2, not shown in the figures. If the measured ego speed 101 deviates from the target speed 100, the control system 3 may recalculate the control signals 300. Such a recalculating of the control signals 300 may be performed repeatedly such that a control loop is executed repeatedly for controlling the ego speed 101. The target speed 100 may be used as a set point for the ego speed 101 for executing the control loop.

The control system 3 may be configured to compute a weighted sum of the further speeds, in the following also referred to as sum_{w}, in order to perform the weighting of the further speeds. The weighted sum may be a sum of a respective product of the respective further speed v_{i,lead} and a respective weighting factor wᵢ. Hence, the control system 3 may be designed to compute the weighted sum according to the following formula:

$${sum}_{w} = {\sum }_{i = 1}^{n} ( {w}_{i} \cdot {v}_{i , lead} ) ,$$

wherein
a total number of the leading vehicles, which are considered for computing the target speed 100, may be given by n and i may correspond to the respective leading vehicle. The target speed 100 may be equal to the weighted sum of the further speeds in one example. According to another example, the target speed 100 may be computed dependent on the weighted sum, for example by multiplying the weighted sum with a correction factor. The total number of the leading vehicles n may be equal to two according to the example shown in FIG. 2. However, the total number n may also be equal to three or may even take values of up to five or more in some applications.

In one example, the control system 3 may be configured to adapt the weighting of the respective further speed v_{i,lead} to a traffic situation involving the vehicle 2 and the at least two further vehicles 21, 22. This may involve adapting the respective weighting factor wᵢ to the traffic situation. Adapting the weighting of the respective further speed v_{i,lead} to the traffic situation may be realized by adapting the weighting of the further speeds dependent on a respective driving pattern of the respective further leading vehicle. In this case, the traffic situation may be specifiable by the respective driving pattern. The control system 3 may be configured to detect the respective driving pattern dependent on the sensor data 200. The respective driving pattern may involve a respective distance of the respective leading vehicle from the vehicle 2 in one example.

In one example, the respective driving pattern may involve a respective fluctuation of the respective further speed v_{i,lead} over time, in the following also referred to as respective speed fluctuation. The control system 3 may be configured to adapt the weighting of the further speeds such that the more constant the respective further speed is over time, the stronger or greater amount the respective further speed is weighted. The control system 3 may be configured to adapt the respective weighting factor wᵢ such that there is a negative correlation between an increase of the respective weighting factor wᵢ and an increase of the respective speed fluctuation. In one example, the respective weighting factor wᵢ may increase proportionally with a decrease of the respective speed fluctuation.

The respective speed fluctuation, in the following also referred to as ξ_{i,lead} in the formulas below, may be calculated in different ways. According to one example, the control system 3 may be configured to compute the respective speed fluctuation as a function of a respective absolute value of a respective difference between a respective averaged speed of the respective leading vehicle and the respective further speed as follows:

$${ξ}_{i , lead} = {\int }_{{t}_{1}}^{{t}_{2}} \vert {v}_{i , lead} - {v}_{i , lead , m} \vert dt ,$$

v_{i,lead,m} indicates the respective averaged speed of the respective leading vehicle i during a time interval which starts at t₁ and ends at t₂. During the time interval the respective further speed v_{i,lead} is detected by the sensor system 4 and the control system 3 at various instances of time. A discretization method may be applied using these values in order to calculate the integral. According to another aspect, the control system 3 may be configured to compute the respective speed fluctuation ξ_{i,lead} as follows:

$${ξ}_{i , lead} = {\int }_{{t}_{1}}^{{t}_{2}} {( {v}_{i , lead} - {v}_{i , lead , m} )}^{2} dt .$$

According to this aspect, greater deviations of the respective further speed from the respective averaged speed may influence the value of the respective speed fluctuation ξ_{i,lead} stronger or greater amount compared to the example described above. According to a further aspect, the control system 3 may be configured to compute the respective speed fluctuation as follows:

$${ξ}_{i , lead} = \sqrt{{\int }_{{t}_{1}}^{{t}_{2}} {( {v}_{i , lead} - {v}_{i , lead , m} )}^{2} dt .}$$

According to this aspect, the respective speed fluctuation may be calculated similar to a respective standard deviation of the respective further speed. This may allow to use statistical methods and/or neural networks for controlling the ego speed 101 in an easier or more desirable manner.

The aspects described above for calculating the respective speed fluctuation may only serve as examples. However, independently of the aspect for calculating the respective speed fluctuation, the control system 3 may be configured to calculate the respective speed fluctuation such that the respective speed fluctuation is greater, the more frequently and/or the more strongly the respective further speed v_{i,lead} deviates from the respective averaged speed v_{i,lead,m} during the time interval.

According to one embodiment, the respective driving pattern may involve a respective fluctuation of a respective acceleration of the respective further vehicle over time, in the following also referred to as respective acceleration fluctuation. According to this embodiment, the control system 3 may be configured to adapt the weighting of the further speeds such that the more constant the respective acceleration is over time, the stronger or greater amount the respective further speed is weighted.

Similar to the consideration of the variations of the further speeds, the control system 3 may be configured to adapt the respective weighting factor wᵢ such that there is a negative correlation between an increase of the respective weighting factor wᵢ and an increase of the respective acceleration fluctuation. In one example, the respective weighting factor wᵢ may increase proportionally with a decrease of the respective acceleration fluctuation.

The respective acceleration fluctuation, in the following also referred to as v_{i,lead}, may be calculated in different ways. According to one example, the control system 3 may be configured to compute the respective acceleration fluctuation as follows:

$${ψ}_{i , lead} = {\int }_{{t}_{1}}^{{t}_{2}} \vert {a}_{i , lead} - {a}_{i , lead , m} \vert dt ,$$

α_{i,lead} indicates the respective acceleration and α_{i,lead,m} indicates a respective averaged acceleration of the respective leading vehicle i during the time interval which starts at t₁ and ends at t₂. During the time interval the respective acceleration α_{i,lead} is detected by the sensor system 4 and the control system 3 or calculated by the control system 3 using the respective further speed at various instances of time. These detected values may be used in order to calculate the last integral mentioned by a discretization method.

According to another aspect, the control system 3 may be configured to compute the respective acceleration fluctuation as follows:

$${ψ}_{i , lead} = {\int }_{{t}_{1}}^{{t}_{2}} {( {a}_{i , lead} - {a}_{i , lead , m} )}^{2} dt .$$

According to this aspect, greater deviations of the respective acceleration from the respective averaged acceleration may influence the value of the respective acceleration fluctuation stronger compared to the example described above.

According to a further aspect, the control system 3 may be configured to compute the respective acceleration fluctuation as follows:

$${ψ}_{i , lead} = \sqrt{{\int }_{{t}_{1}}^{{t}_{2}} {( {a}_{i , lead} - {a}_{i , lead , m} )}^{2} dt .}$$

According to this aspect, the respective acceleration fluctuation may be calculated similar to a respective standard deviation of the respective acceleration fluctuation. This may allow to use statistical methods and/or neural networks for controlling the ego speed 101 in an easier or desirable manner.

Independently of the aspect for calculating the respective acceleration fluctuation, the control system 3 may be configured to calculate the respective acceleration fluctuation such that the respective acceleration fluctuation is greater, the more frequently and/or the more strongly the respective further acceleration deviates from the respective averaged acceleration during the time interval. The respective acceleration fluctuation may represent a respective kinetic intensity of the respective leading vehicle.

According to the example, shown in FIG. 5, the control system 3 may be configured to perform the weighting of the respective further speed dependent on a database 50. The database 50 may include a respective relationship between the respective weighting factor wᵢ for performing the weighting of the respective further speed and at least one parameter for describing the traffic situation. The database 50 may be stored in a memory modules 51 of the control system 3. The one or more processors 52 of the control system 3 may load the database 50 in a cache of the one or more processors 52 for performing the weighting.

In one example, the control system 3 may compute the respective weighting factor wᵢ dependent on an input file 60 using the database 50, as shown in FIG. 6. The input file 60 may include a value of the at least one parameter for describing the traffic situation. In most cases, the input file 60 may include a set of values for describing the traffic situation. For example, the input file 60 may include the respective distance of the respective leading vehicle to the vehicle 2, the respective further speed, the respective speed fluctuation and/or the respective acceleration fluctuation.

The previously mentioned respective relationship of the database 50 may respectively relate the respective weighting factor wᵢ with the respective distance, the respective further speed, the respective speed fluctuation and/or the respective acceleration fluctuation. The respective relationship may be provided in the form of a respective function. The respective function may be realized by a neural net in one example. In this case, the database 50 may include data specifying the neural net, such as a number hidden layers, a number of neurons of each layer and values of connection weights connecting these neurons to each other. Alternatively or in addition, the respective relationship may be provided in the form 2-dimensional tables with rows and columns and/or 3-dimensional tables and/or higher dimensional tables. In one example, the database 50 may be structured such that various different sets of respective functions may be provided dependent on the ego speed 101 in order to provide different functions for the weighting factors for different values of the ego speed 101.

According to one aspect of the aforementioned method, the method may further include optimizing the database 50 on the basis of previous traffic situations of the vehicle 2 or a second vehicle. According to this aspect, a respective previous target speed of the vehicle 2 or the second vehicle is determined on the basis of a previous weighting of a respective speed of second further vehicles, not shown in the figures, in front of the vehicle 2 or the second vehicle in the respective traffic situation. The respective previous target speed and the previous weighting may provide a further database. The further database may also include performance data of the vehicle 2 or the second vehicle, such as an average fuel consumption and/or an average acceleration of the vehicle 2 or the second vehicle. The further database may serve for the optimization of the database 50 and thus for an optimization of the respective function. The optimization of the respective function may be performed offline, for example by an external server which is located outside the vehicle 2, or onboard of the vehicle 2. The optimized database 50 may be sent to the control system 3 for storing the database 50 in the memory modules 51. The optimization of the database 50 may be considered as a training of the neural net wherein when the respective function of the database 50 is realized by the neural net.

In the following it is assumed that the control loop is executed during a period of time which includes several time intervals, including the aforementioned time interval. For each time interval a respective speed fluctuation and/or the respective acceleration fluctuation for each of the respective leading vehicle may be calculated in a similar manner as for the aforementioned time interval. In addition, the respective weighting factor wᵢ which may be used for computing the target speed 100 during the respective time interval may be recalculated dependent on the respective speed fluctuation and/or the respective acceleration fluctuation of that time interval which precedes the respective time interval. A length of the time intervals may be equal in one example, and may be in the range of 10 to 20 seconds or higher. The length of the time intervals may be determined by the offline optimization on the external server.

According to results of practical testing, it is favorable if the total number of leading vehicles n to be considered for computing the target speed 100 is equal to three. This may be due to the fact that an optimization of the weighting factors is getting more complex with an increasing total number of leading vehicles involved in the computation of the target speed 100 on the one hand. On the other hand, if the total number n is equal to two, then the variation of the target speed 100 over time may be still quite high compared to an application with the total number n being equal to three. As a consequence, the fuel consumption may be reduced less if the total number n is equal to two compared to an application where the total number n is equal to three.

In one embodiment, the control system 3 may be configured to perform the weighting of the respective further speed wherein when the respective relative distance is greater than a calculated desirable or efficient following distance between the vehicle 2 and the one of the leading vehicles that is closest to the vehicle 2 and less than a predefined threshold distance. Otherwise, i.e. in the other case, the control system 3 may not perform the weighting of the respective speed of the respective further vehicle as described above. Furthermore, the control system 3 may be programmed to not perform the weighting of the respective speed of that respective further vehicle which is further away than the predefined threshold distance, i.e. to switch off the weighting of this respective speed, in the other case. The predefined threshold distance is greater than the calculated desirable or efficient following distance and may be, in a non-limiting example, in a range of 200 to 400 meters. The predefined threshold distance may be larger than 400 meters or less than 200 meters.

Switching off the weighting of the respective further speed of the respective further vehicle wherein when the respective relative distance of that vehicle is greater than the predefined threshold distance may have the advantage that a part of the leading vehicles which are located further away than the predefined threshold distance can be discarded for computing the target speed 100. This may allow to control the ego speed 101 with less computational effort and may further allow a more robust controlling of the ego speed 101. Furthermore, switching off the weighting wherein when the distance between the closest further vehicle and the vehicle 2 is less than the calculated desirable or efficient following distance may increase the desirability or efficiency of the driver-assistance system 1. Switching off the weighting in this case may allow to adjust the distance between the closest further vehicle and the vehicle 2 such that this distance is equal or greater than the desirable or efficient following distance as fast as possible. This may be realized by running a conventional ACC system of the vehicle 2. The conventional ACC system may compute the desirable or efficient following distance dependent on the further speed of the closest further vehicle and the ego speed 101 in one example.

The conventional ACC system may be integrated in the driver-assistance system in one example. In one example, the control system 3 may set the target speed 100 such that the target speed 100 is calculated as described above or is equal to a further target speed which is calculated by the conventional ACC system, whichever is less. This may enhance the desirability or efficiency of the driver-assistance system 1 even further. The conventional ACC system may be operated at different states, such as a speed control mode or a distance control mode. In one example, the weighting is switched off wherein when the conventional ACC system runs in the speed control mode and is switched on wherein when the conventional ACC system runs in the distance control mode.

In a further embodiment, the control system 3 may be configured to adapt the weighting of the further speeds to a respective type of the respective further vehicle. For example, the control system 3 may perform the weighting of the further speeds such that the bigger the respective further vehicle is, the more the further speed of that respective vehicle is weighted. This may reduce the fluctuation of the ego speed 101 as usually bigger vehicles drive at a more constant speed.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A driver-assistance system for controlling a speed of a vehicle dependent on at least two further vehicles in front of the vehicle, the driver-assistance system comprising:
a control system; and
a sensor system configured for detecting a respective further speed of the respective further vehicle,
wherein the control system is configured to:
perform a weighting of the further speeds to each other and to determine a target speed of the vehicle dependent on the respective further speed and dependent on the weighting of the further speeds, and
control the speed of the vehicle dependent on the target speed.

2. The driver-assistance system according to claim 1, wherein the control system is further configured to adapt the weighting to a traffic situation involving the vehicle and the at least two further vehicles.

3. The driver-assistance system according to claim 2, wherein the traffic situation is specifiable by a respective driving pattern of the respective further vehicle and the control system is further configured to adapt the weighting of the further speeds dependent on the respective driving pattern.

4. The driver-assistance system according to claim 3, wherein the respective driving pattern involves a respective fluctuation of the respective further speed over time and the control system is further configured to adapt the weighting of the further speeds such that the more constant the respective further speed is over time, the stronger the respective further speed is weighted.

5. The driver-assistance system according to claim 3, wherein the respective driving pattern involves a respective fluctuation of a respective acceleration of the respective further vehicle over time and the control system is further configured to adapt the weighting of the further speeds such that the more constant the respective acceleration is over time, the stronger the respective further speed is weighted.

6. The driver-assistance system according to claim 1, wherein:
the traffic situation involves a respective relative distance of the respective further vehicle to the vehicle; and
the control system is further configured to perform the weighting of the respective further speed wherein when the respective relative distance is greater than a calculated desirable following distance between the vehicle and the one of the further vehicles that is closest to the vehicle and less than a predefined threshold distance, wherein the predefined threshold distance is greater than the calculated desirable following distance.

7. The driver-assistance system according to claim 1, wherein the control system is further configured to adapt the weighting of the further speeds to a respective type of the respective further vehicle.

8. The driver-assistance system according to claim 2, wherein the control system is further configured to perform the weighting dependent on a database, wherein the database includes a respective relationship between a respective weighting factor for performing the weighting of the respective further speed and at least one parameter for describing the traffic situation.

9. A method for controlling a speed of a vehicle dependent on at least two further vehicles in front of the vehicle, the method comprising the following steps:
detecting a respective further speed of the respective further vehicle by a sensor system;
performing a weighting of the further speeds to each other by a control system;
determining a target speed of the vehicle dependent on the respective further speed and dependent on the weighting of the further speeds by the control system; and
controlling the speed of the vehicle dependent on the target speed by the control system.

10. A computer program product comprising:
a computer-readable storage medium having computer-readable program instructions embodied therewith, the computer-readable program instructions, when executed by a processor, cause the processor to:
detect a respective further speed of the respective further vehicle of a sensor system;
perform a weighting of the further speeds to each other by a control system;
determine a target speed of the vehicle dependent on the respective further speed and dependent on the weighting of the further speeds by the control system; and
control the speed of the vehicle dependent on the target speed by the control system.
